(19) United States
(12) Patent Application Publication
(10) Pub. No.: US 2011/0269054 A1
(43) Pub. Date: Nov. 3, 2011

(54) FUEL CELL WITH A BRAZED INTERCONNECT AND METHOD OF ASSEMBLING THE SAME

(75) Inventor: Wayne Charles Hasz, Pownal, VT (US)

(73) Assignee: GENERAL ELECTRIC COMPANY, Schenectady, NY (US)

(21) Appl. No.: 13/183,161

(22) Filed: Jul. 14, 2011

Related U.S. Application Data
(63) Continuation-in-part of application No. 11/312,795, filed on Dec. 20, 2005.

(51) Int. Cl. H01M 8/10; B23K 31/02; H01M 8/00

(52) U.S. Cl. 429/479; 429/535; 228/256

(57) ABSTRACT

A fuel cell including an anode, a cathode and an electrolyte interposed between the anode and the cathode is disclosed. The fuel cell also includes an anode interconnect disposed adjacent to the anode, and a brazing material disposed between the anode interconnect and the anode to bond the anode interconnect to the anode. A method of assembling a fuel cell including forming a package of an anode and an electrolyte is also disclosed. It includes heating the package with a brazing material disposed adjacent to the anode, to bond the anode to an interconnect.

### CROSS REFERENCE TO RELATED APPLICATIONS

This application is a Continuation-In-Part of U.S. patent application Ser. No. 11/312,795, entitled “FUEL CELL WITH A BRAZED INTERCONNECT AND METHOD OF ASSEMBLING THE SAME”, filed Dec. 20, 2005, which is herein incorporated by reference.

### BACKGROUND

The invention is directed generally to fuel cells, and more specifically, to solid oxide fuel cell system with efficient interconnecting arrangements and sealing mechanisms.

Fuel cells are electrochemical devices that convert chemical energy into electricity. More specifically, the electricity is produced by catalyzing fuel and oxidant into ionized atomic hydrogen and oxygen at an anode and a cathode, respectively. A series of electrochemical reactions in the cells are the sole means of generating electric power within the fuel cell. A typical fuel cell includes an anode, an anode interconnect, an anode bond paste, an electrolyte, a cathode, a cathode bond paste and a cathode interconnect. The anode bond paste is used to adhere the anode to the anode interconnect, while the cathode bond paste is used to adhere the cathode to the cathode interconnect. Electrons removed from hydrogen in an ionization process at the anode are conducted to the cathode where they ionize oxygen.

Solid oxide fuel cells (SOFC) have attracted considerable attention because of their efficiency in generating electricity while operating at high temperatures, typically above about 650° C. In the case of an SOFC, the oxygen ions are conducted through a ceramic electrolyte, where they combine with ionized hydrogen to form water as a waste product, completing the process. The electrolyte is otherwise impermeable to both fuel and oxidant, and merely conducts oxygen ions.

In almost all types of fuel cells, steps need to be taken to provide gas flow barriers within various structures of the cells. For example, it is usually critical that direct contact between fuel gases such as hydrogen, and oxidizing gases like oxygen, be completely prevented. (Mixing of these types of gases can lead to explosions and fire). Providing adequate seals within SOFC's can present special challenges, because of the high temperature environment in which the seals must function.

SOFC's are typically assembled in electrical series in a fuel cell assembly to produce power at useful voltages. To create an SOFC assembly, an interconnecting member is used to connect adjacent SOFC's together in electrical series. The anode and cathode interconnects are usually bonded by a bond paste to each SOFC.

When placed into service, the anode of such fuel cells is often chemically reduced, such as from nickel oxide to elemental nickel. The chemical reduction can result in a change in size, particularly when the device is subjected to temperature cycling during use. However, the bond paste used to connect the anode to the anode interconnect is fairly low in strength. Therefore, delamination can occur after reduction of the anode. Delamination is a process in which layers of composite materials separate over time, due to repeated cyclic stresses or any kind of impact causing a loss in mechanical integrity. This also may lead to cracking of the electrolyte that is typically made of a ceramic compound. In addition, attempts to remedy such problems with excess bond paste can lead to blockage of air and fuel flow in a fuel cell assembly. Another significant challenge is that once the SOFC is sealed and bonded in place, it is subject to volume changes during anode reduction. Again, the SOFC itself may crack or delaminate during post-bonding anode reduction.

Therefore, there is a need for a fuel cell assembly that is sealed and interconnected in an efficient way to avoid the cracking of the fuel cells and other degradation of the components of fuel cells, and the interconnections between them.

### BRIEF DESCRIPTION

In accordance with one aspect of the invention, a method of assembling a fuel cell is provided, comprising the steps of:
a) forming a package of an anode and an electrolyte;
b) chemically reducing the package; and
c) applying a brazing material to bond an interconnect to the chemically-reduced anode-electrolyte package.

In other embodiments, another method of assembling a fuel cell comprises:
I) forming a package of an anode and an electrolyte;
II) chemically reducing the package;
III) forming an array of perforations in a metallic interconnect, wherein the perforations allow the passage of fuel to the anode; and wherein a webbing is formed by the surface area between the perforations;
IV) applying a brazing material around at least a portion of a perimeter of the webbing, so that the brazing material is adjacent to the anode; and
V) positioning the interconnect in a desired location relative to the chemically-reduced package; and heating the package with the brazing material, to connect the package to the interconnect through the webbing.

In accordance with another aspect of the invention, a fuel cell is provided, comprising:
i) an anode, a cathode; and an electrolyte interposed between the anode and the cathode;
ii) an anode interconnect disposed adjacent to the anode; and
iii) a brazing material disposed between the anode interconnect and the anode, to bond the anode interconnect to the anode, and to form a gas-tight, perimeter seal therebetween.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional view of an SOFC including an anode, an electrolyte and a cathode with a brazed interconnect in accordance with the invention;

FIG. 2 is a sectional view of a brazed SOFC including an anode interconnect with an inlet for incoming fuel gas and an outlet for outgoing fuel gas in accordance with the invention;

FIG. 3 is a top view of a brazed SOFC in FIG. 2 including an anode interconnect in accordance with the invention;

FIG. 4 is a diagrammatic representation of an interconnect contact surface with perforations on a contact surface for brazing in accordance with embodiments of the invention;

FIG. 5 is an exploded view of an anode bonded to the interconnect in FIG. 4 using a brazing material disposed around a webbing of the interconnect in accordance with embodiments of the invention;

FIG. 6 is a flow chart of a method of assembling an SOFC, where a cathode is disposed on a package including a reduced brazed anode and an electrolyte; and

FIG. 7 is a flow chart of a method of assembling an SOFC, where a package of an anode, an electrolyte and a cathode are reduced and brazed together.

### DETAILED DESCRIPTION

As discussed in detail below, embodiments of the present invention provide a fuel cell and a method of assembling a fuel cell. The fuel cell described herein includes an anode interconnect with a brazing (metallic) material or “braze”, an anode, an electrolyte, a cathode, and a cathode interconnect with a bonding material. The bonding material may include a braze or a cathode bond paste. The brazing material is used to adhere the anode interconnect to the anode, and in some instances, the cathode interconnect to the cathode.

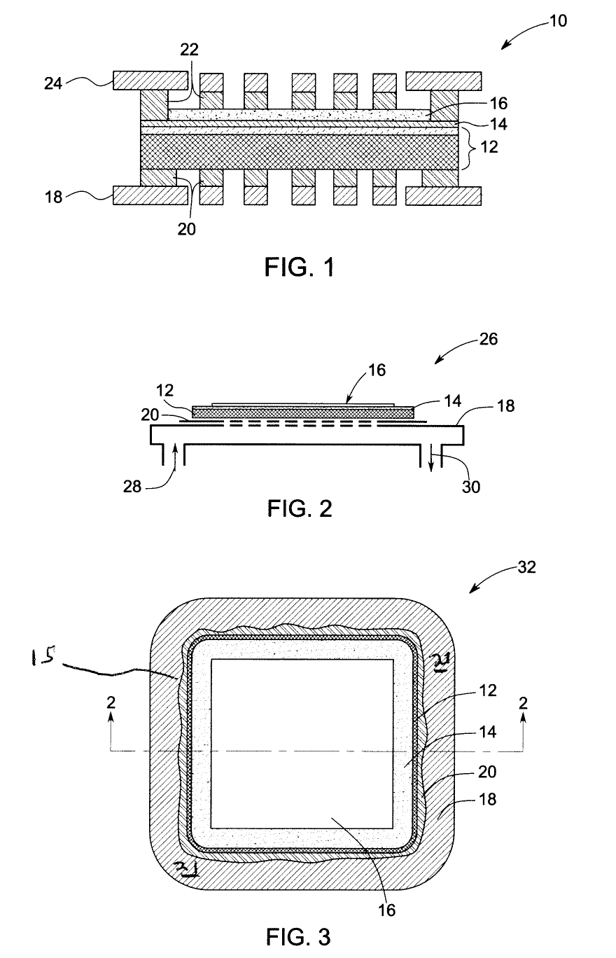

Turning now to the drawings, FIG. 1 is a cross sectional view of an exemplary embodiment of a fuel cell 10. In the illustrated embodiment, the fuel cell 10 is an SOFC. The fuel cell 10 includes an anode 12, an electrolyte 14, and a cathode 16, in a package as shown. The electrolyte 14 is interposed between the anode 12 and the cathode 16. The anode 12 is adhered to an anode interconnect 18 by a brazing material 20. The cathode 16 is also adhered to a cathode interconnect 24 by a bonding material 22. The brazing material 20 can also be used at the periphery between the anode 12 and the anode interconnect 18 to act as a sealant to gas flow. The bonding material 22 may be a braze or a cathode bond paste.

The anode 12 provides reaction sites for the electrochemical oxidation of a fuel introduced into the fuel cell. In addition, the anode material is stable in the fuel-reducing environment, has adequate electronic conductivity, surface area and catalytic activity for the fuel gas reaction at the fuel cell operating conditions, and has sufficient porosity to allow gas transport to the reaction sites. The anode can be made of a number of materials having these properties, such as metals including nickel (Ni), Ni alloy, silver (Ag), copper (Cu), noble metals, cobalt, ruthenium, as well as other materials, such as Ni-yttria stabilized zirconia (YSZ) cermet, copper Cu-YSZ cermet, ceramics, or combinations thereof.

Electrolyte 14 is stacked upon anode 12, typically via deposition or lamination. During fuel cell operation, the electrolyte conducts ions between the anode 12 and the cathode 16. The electrolyte carries ions produced at one electrode to the other electrode to balance the charge from the electron flow and complete the electrical circuit in the fuel cell. Additionally, the electrolyte separates the fuel from the oxidant in the fuel cell. Accordingly, the electrolyte is generally stable in both reducing and oxidizing environments, impermeable to reacting gases, and adequately conductive at operating conditions. Typically, the electrolyte is electronically insulating. The SOFC electrolyte can be made of a number of materials having these properties, such as zirconium oxide (ZrO₂), yttria stabilized zirconia (YSZ), cerium oxide (CeO₂), bismuth sesquioxide, pyrochlore oxides, doped zirconates, perovskite oxide materials, or a ceramic compound of a metal oxide, such as an oxide of calcium or zirconium, or combinations thereof.

As shown in FIG. 1, cathode 16 is disposed upon the electrolyte 14. The cathode provides reaction sites for the electrochemical reduction of the oxidant. Accordingly, the cathode is chosen such that it is stable in the oxidizing environment, has sufficient ionic and electronic conductivity, surface area and catalytic activity for the oxidant gas reaction at the fuel cell operating conditions, and has sufficient porosity to allow gas transport to the reaction sites. The cathode can be made of a number of materials having these properties, such as an electrically conductive oxide, perovskite, doped (LaMnO₃), Sr-doped LaMnO₄ (LSM), tin doped indium oxide (In₂O₃), strontium-doped praseodymium manganese trioxide (PrMnO₃), lanthanum iron oxide-lanthanum cobalt oxide (LaFeO₃—LaCoO₃), ruthenium oxide yttria stabilized zirconia (RuO₂-YSZ), lanthanum cobaltite (La cobaltite), and combinations thereof.

In the exemplary embodiment of the invention as shown in FIG. 2, a cross-sectional view 26 of the fuel cell 10 (shown in FIG. 1) is illustrated. It also illustrates access paths for fuel gas as explained below. As noted above, the fuel cell includes a cathode 16 stacked upon an electrolyte 14, which in turn is disposed upon an anode 12. An anode interconnect 18 is bonded to the anode 12 by a brazing material 20. An inlet for incoming fuel gas 28 and an outlet for spent fuel gas 30 are provided on the anode interconnect 18. In an example, the fuel cell may be a SOFC.

FIG. 3 illustrates a top view 32 of the fuel cell shown in FIG. 2. The top layer shown in FIG. 3 is the cathode 16, disposed upon the electrolyte 14, which in turn is stacked upon the anode 12. The anode interconnect 18 is configured to provide access for fuel gas, by providing an inlet for allowing incoming fuel gas 28, and an outlet for spent fuel gas 30. Suitable configurations for use as an anode interconnect may include a metallic lanced off-set corrugation, a perforated metallic sheet, and a metallic foam.

With continued reference to FIG. 3, a brazing material 20, described with reference to FIGS. 1 and 2, is deposited between the anode 12 and an anode interconnect 18. In this embodiment, the brazing material is disposed completely (or nearly completely), around the perimeter 15 of the interconnect surface 21, i.e., surrounding anode 12. (While the entire surface 21 could be thought of as the “perimeter” region, the term is meant to be directed to the region immediately adjacent the anode). In practice, the brazing material can actually be applied continuously around the perimeter region, or it can be applied at periodic locations, and then melted and caused to flow around the perimeter. Moreover, the brazing material could alternatively (or additionally) be applied to a corresponding region on the overlying structure to be bonded to the interconnect—usually the anode-electrolyte package, as mentioned below. The brazing material 20 thus forms a perimeter seal between the anode and the anode interconnect.

In general, the braze material for most embodiments performs a number of important functions. It provides a durable, relatively pliant mechanical bond between the anode and the interconnect. It also provides good electrical contact between the two structures. Finally, the braze functions as a liquid- and gas-impermeable (hermetic) seal, as mentioned above. The seal effectively prevents undesirable contact between air/oxygen gas streams and fuel streams (e.g., hydrogen or methanol). Moreover, the braze material can provide a more durable, flexible seal, as compared to conventional glass seals of the prior art. For example, a metallic-based braze composition can allow for greater dimensional differences (e.g., in terms of CTE, or coefficient of thermal expansion) between the anode structure and the interconnect. This attribute is especially important when the fuel cells are subjected to a large number of heating and cooling cycles.

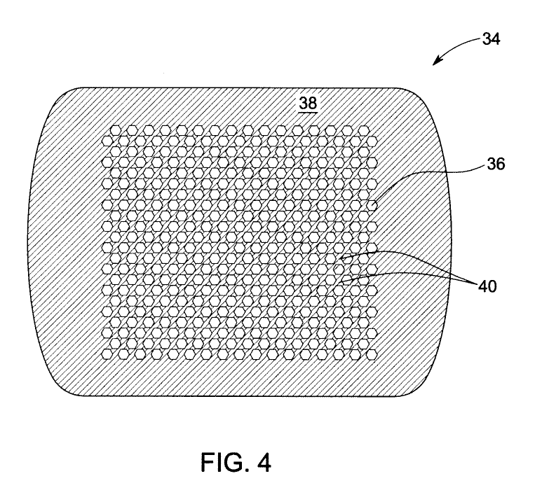

FIG. 4 is a diagrammatic representation of another embodiment of the invention, wherein an interconnect 34 is shown. The interconnect 34 includes an array of openings or perforations 36 through an interconnect contact surface 38. (In some embodiments, the array is characterized by a hexagonally close-packed pattern, although other patterns are possible; or no specific pattern is also possible). The interconnect contact surface 38 provides sufficient contact area to provide a good mechanical bond to a fuel cell, while also providing good electrical contact and fuel gas access to the anode (not shown). It has been found that the provision of perforations through the interconnect facilitates access for fuel gas to the anode. The surface area between the perforations is referred to as “webbing” 40, around which the brazing material is disposed, for bonding the anode or the cathode to the interconnect. The webbing/perforation structure also provides greater surface area for attachment of the interconnect to the rest of the cell structure.

(The interconnect 34 may be an anode interconnect or a cathode interconnect, depending on the particular structure and orientation of the fuel cell). Suitable materials that may be used in interconnects include high chrome stainless steels, Ni alloys, noble metals and any metal that remains conductive and stable at the SOFC operating conditions. Typical properties that are considered in choosing an interconnect material are high-temperature oxidation resistance, electrical conductivity, adhesion of oxide scale, thermal expansion, manufacturing process and cost. In an example, the thickness of the interconnect may vary from 0.010 inch to 0.125 inch.

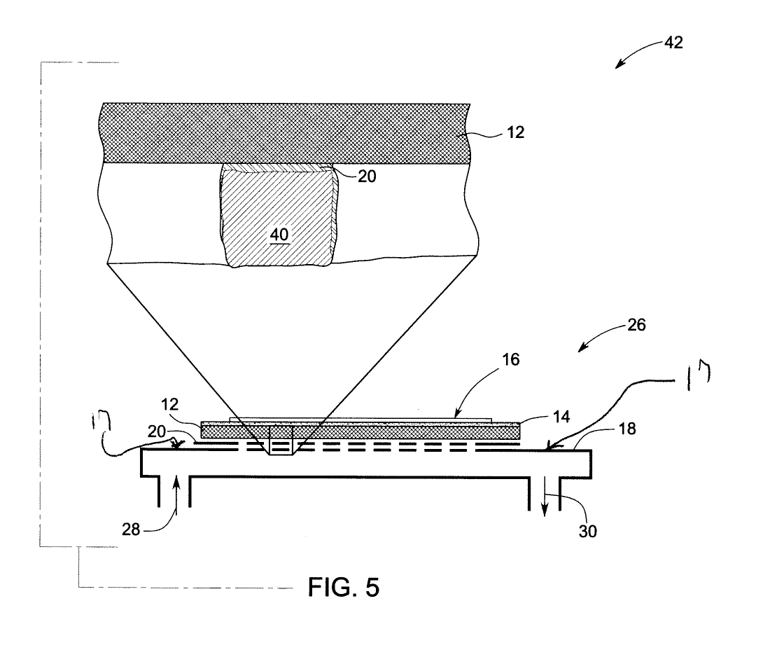

FIG. 5 is an exploded cross sectional view 42 depicting bonding of the anode 12 to the interconnect 34, as referenced to in FIG. 4. In the illustrated embodiment, the brazing material 20 is disposed around a portion, or around the entirety of the webbing 40 of the interconnect 34. The brazing material can be disposed at periodic spacings along the length of the interconnect 34. The spacings are maintained such that the bonding of the brazing material is sufficient enough to ensure that a pressure difference between one side of the interconnect and an opposite side of the fuel cell acting over an unsupported SOFC length does not crack the fuel cell. An example of the spacing may be between 0.0625 inch and 0.5 inch. FIG. 5 further shows the additional elements of the SOFC shown in the cross sectional view 24 of FIG. 2, namely the cathode 16, the electrolyte 14, the anode 12, the anode interconnect 18, the inlet for incoming fuel gas 28, and the outlet for spent fuel gas 30.

In the embodiment of FIG. 5, it is usually very important that the brazing material completely fill the region between the anode-electrolyte (AE) structure 12/14 and the corresponding surface 17 of the anode interconnect 18. In this manner, the braze material can bond the AE structure to the interconnect, around the perimeter region (i.e., the non-perforated, non-webbed area) of interconnect surface 17. As in the embodiment of FIGS. 2 and 3, the braze provides a compliant mechanical bond between the anode and the interconnect, through the webbing. Good electrical contact is also maintained. Moreover, upon cooling, the braze forms the gas-tight seal that is very important for embodiments of the invention, as discussed previously.

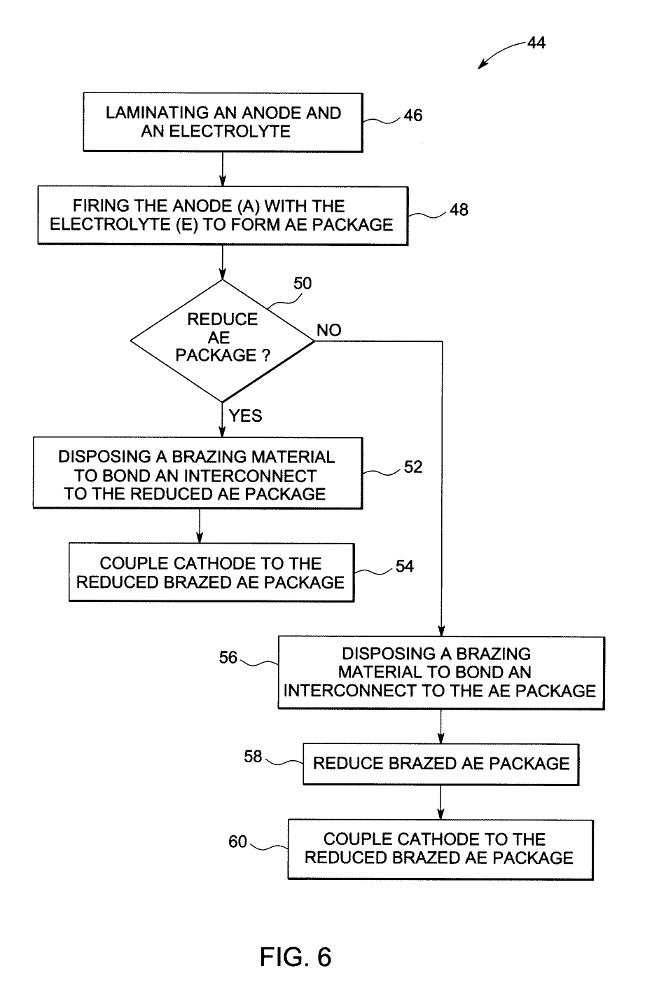

FIG. 6 is a flow chart 44 illustrating exemplary steps involved in a method of assembling a fuel cell, according to aspects of present invention. The method includes laminating an anode and an electrolyte of a fuel cell at step 46. The anode is then fired to the electrolyte to form the anode-electrolyte (AE) package in step 48. Following formation of the AE package, it may be chemically reduced in step 50. A brazing material is then disposed (applied and brazed) on the interconnect to bond the interconnect to the reduced AE package at step 52. The reduced brazed AE package is further coupled to a cathode at step 54.

Assuming the AE package is not chemically reduced in step 50, the method usually includes step 56, i.e., disposing a brazing material on an interconnect to bond the interconnect to the AE package. The brazed AE package may become reduced during the brazing step, after which a cathode is coupled to such a package, as referred to in step 60. In the case of a partially reduced anode, an in-situ reduction step is usually employed; where an entire assembled fuel cell stack is brought up to temperature with a reducing gas on an anode side, to completely reduce the anode before electrical power is produced. Disposing the brazing material to bond an interconnect also includes heating the AE package with the brazing material deposited adjacent to the anode, to bond the anode to the interconnect. Prior to disposing the brazing material, the method also includes forming a perforation in the interconnect. The brazing material is then deposited on the interconnect. The brazing material may also be disposed around a periphery of the anode to form a seal to the gas flow upon heating, as described above.

With continuing reference to FIG. 6, some preferred embodiments of this invention require the chemical reduction of the AE package immediately after its formation, or at least before other steps are carried out. This pathway, through steps 52 and 54, can be very important, since bonding of ceramic (or “cermet”) materials to other ceramics, or to metals, can often be very difficult. The difficulty is due in large part to the brittle nature of the oxide-type ceramics, which can invite cracking when any type of strain is imposed, e.g., in brazing steps. The chemical reduction can alleviate or eliminate this problem, by reducing the nickel oxide (e.g., YSZ) species to a metal, like nickel, which is much more compliant than the ceramic. In this manner, the integrity of the braze and the surrounding connections can be considerably improved.

When reduction of the package is carried out prior to any brazing step (i.e., following step 50 of FIG. 6), there may be no volumetric change, or shrinkage of the fuel cell, after bonding of the package to the interconnect. This is due to the fact that no further anode reduction is involved, during the later brazing steps. The dimensional stability achieved in this manner can also be very important for the integrity of the fuel cell construction.

A number of braze materials may be used in the bonding steps of this invention, with the proviso that the braze chemistry and processing conditions bond the SOFC components. without degrading their properties. The braze material usually (though not always) includes nickel, e.g., at least about 40% nickel in some compositions. Other elements are also usually present, like chromium, and, possibly, aluminum or yttrium. The braze alloy composition also typically contains one or more components for lowering its melting point. Examples of melting point suppressants for nickel-base alloy compositions are silicon, boron, and phosphorous. Silicon or boron, or combinations thereof, are often preferred. The braze alloy composition may also contain other additives known in the art, e.g., fluxing agents. Non-limiting examples of nickel-containing brazes are NiCrSi, NiCrB, NiCrSiB, NiCuMn, and NiCrP. Combinations of such materials are also possible, and other elements may also be included, as mentioned above.

Other types of braze alloys may be used. Non-limiting examples include manganese-containing brazes; or precious metal compositions containing silver, gold, platinum, and/or palladium, in combination with other metals, such as copper, manganese, nickel, chromium, silicon, and boron. Many of the metal braze compositions are available from Praxair Surface Technologies, Inc. Moreover, the braze material is usually employed in the form of a slurry. The slurry usually contains at least one binder and a solvent.

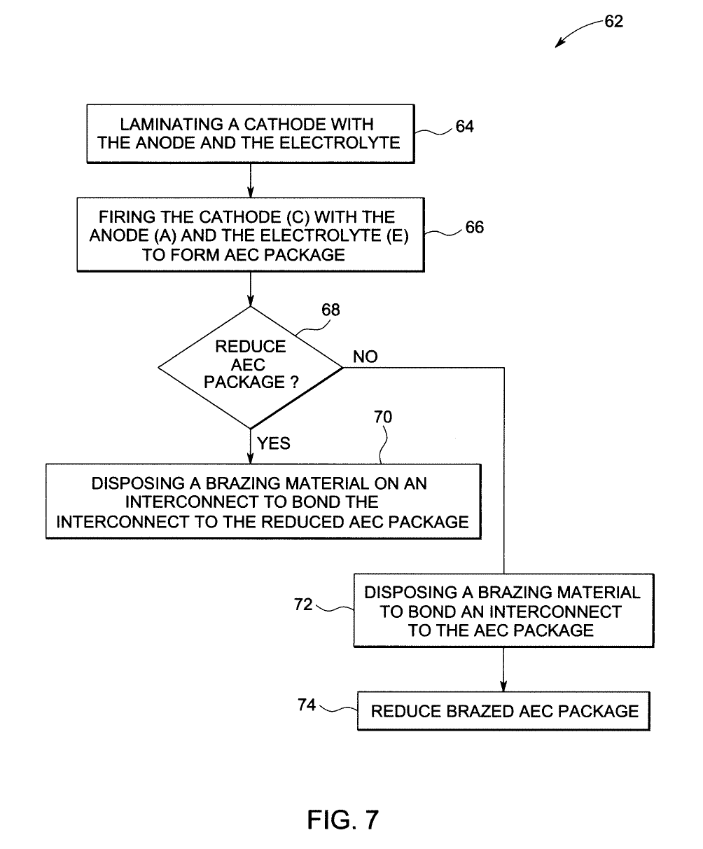

FIG. 7 is a flow chart 62, illustrating exemplary steps for a method of assembling a fuel cell. The method includes at step 64, laminating a cathode with a previously fired anode and an electrolyte. The cathode is further fired to the anode and the electrolyte to form an anode-electrolyte-cathode (AEC) package at step 66. Following the formation of the AEC package, it may be chemically reduced in step 68. A brazing material is then disposed on an interconnect to bond the interconnect to the reduced AEC package in step 70. As in previous embodiments, chemical reduction in this sequence can have important advantages.

In the case when there is no chemical reduction in step 68, the method includes a step 72 of disposing a brazing material to bond an interconnect to the AEC package. The anode side of the brazed AEC package is then reduced in step 74 (as described in paragraph 26). Disposing the brazing material to bond an interconnect includes heating the AEC package with the brazing material deposited adjacent to the anode and the cathode, to bond the anode and the cathode to the interconnect. Prior to disposing the brazing material, the method also includes forming a perforation in the interconnect and the brazing material is deposited on the interconnect. The brazing material may also be disposed around a periphery of the anode and the cathode to form a seal to the gas flow upon heating.

As will be appreciated by those skilled in the art, disposition of a brazing material on an interconnect helps in reducing the possibility of breakage or cracking in the fuel cell. In a typical SOFC, an anode bond paste and a cathode bond paste do not provide good support over the relatively large surface area of an interconnect. In the present invention, the brazing material helps in providing adequate support. It has also been found that disposing the brazing material on the interconnect also addresses the issue of lack of electrical contact to the anode or cathode, due to poor bonding of the anode and cathode bond paste. It is also possible to add extra braze at a perimeter of the SOFC to act as a gas seal, as described above.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of assembling a fuel cell, comprising the steps of
a) forming a package of an anode and an electrolyte;
b) chemically reducing the package; and
c) applying a brazing material to bond an interconnect to the chemically-reduced anode-electrolyte package.

2. The method of claim 1, wherein the fuel cell comprises a solid oxide fuel cell.

3. The method of claim 1, wherein forming the package comprises firing the anode to the electrolyte.

4. The method of claim 1, wherein forming the package comprises laminating the anode to the electrolyte.

5. The method of claim 1, wherein the brazing material is applied around a perimeter of the interconnect surface, surrounding the anode, so as to form a gas-tight and liquid-tight seal, upon cooling.

6. The method of claim 1, wherein the brazing material comprises nickel.

7. The method of claim 6, wherein the brazing material further comprises at least one of boron and silicon.

8. The method of claim 6, wherein the brazing material further comprises at least one metal selected from the group consisting of chromium, copper, manganese, and a precious metal.

9. A method of assembling a solid oxide fuel cell, comprising:
I) forming a package of an anode and an electrolyte;
II) chemically reducing the package;
III) forming an array of perforations in a metallic interconnect, wherein the perforations allow the passage of fuel to the anode; and wherein a webbing is formed by the surface area between the perforations;
IV) applying a brazing material around at least a portion of a perimeter of the webbing, so that the brazing material is adjacent to the anode; and
V) positioning the interconnect in a desired location relative to the chemically-reduced package; and heating the package with the brazing material, to connect the package to the interconnect through the webbing.

10. The method of claim 9, further comprising the step of attaching a cathode to the anode-electrolyte package, so that the electrolyte is interposed between the anode and the cathode.

11. The method of claim 10, further comprising attaching a cathode interconnect to the cathode.

12. A fuel cell, comprising:
i) an anode, a cathode; and an electrolyte interposed between the anode and the cathode;
ii) an anode interconnect disposed adjacent to the anode; and
iii) a brazing material disposed between the anode interconnect and the anode, to bond the anode interconnect to the anode, and to form a gas-tight, perimeter seal therebetween.

13. The fuel cell of claim 12, wherein the anode interconnect comprises a perimeter region and a webbing within the perimeter region, said webbing being formed by the surface area between an array of perforations; and wherein the brazing material seals the anode to the interconnect through the webbing.

14. A solid oxide fuel cell according to claim 12.
